(19) United States
(12) Patent Application Publication
(10) Pub. No.: US 2024/0212265 A1
(43) Pub. Date: Jun. 27, 2024

(54) Generative VR World Creation from Natural Language

(71) Applicant: Meta Platforms Technologies, LLC, Menlo Park, CA (US)

(72) Inventors: Divya AGARWAL, San Francisco, CA (US); Khushhall Chandra MAHAJAN, Surrey, CA (US); Vinaykumar Subrahmanya HEGDE, San Jose, CA (US)

(21) Appl. No.: 18/496,090

(22) Filed: Oct. 27, 2023

Related U.S. Application Data
(60) Provisional application No. 63/476,383, filed on Dec. 21, 2022.

(51) Int. Cl. G06T 17/00; G06T 19/20; G10L 15/18; G10L 15/183; G10L 15/22

(52) U.S. Cl. CPC G06T 17/00; G06T 19/20; G10L 15/1815; G10L 15/183; G10L 15/22; G06T 2210/61; G10L 2015/223

(57) ABSTRACT

Aspects of the present disclosure are directed to generating virtual environments based on plain language commands. A natural language command processor can analyze a user's voice command to infer at least a location and an experience described in the spoken command. The inferred location and experience can be provided as inputs to a generative virtual environment builder trained on real-world data—such as photos and videos captured by users engaging in various activities at various locations—which generates a navigable 3D virtual environment that can include a skybox, virtual objects (and their respective locations), or some combination thereof. The generated virtual environment can be iteratively modified with additional natural language commands to update aspects of the environment and/or to add additional details or objects to the virtual environment.

### CROSS-REFERENCE TO RELATED APPLICATIONS

This application claims priority to U.S. Provisional Patent Application No. 63/476,383, titled “ Generative VR World Creation From Natural Language,” filed Dec. 21, 2022, which is herein incorporated by reference in its entirety.

### TECHNICAL FIELD

The present disclosure is directed to artificial reality and machine learning systems where natural language commands are used to automatically generate artificial reality environments.

### BACKGROUND

Users interacting with artificial reality (XR) devices can view content in an artificial reality environment that includes real-world objects and/or two-dimensional (2D) and/or three-dimensional (3D) virtual objects. For example, the XR environment can be a virtual environment depicted by a virtual reality (VR) device showing a set of virtual objects. As another example, the XR environment can a mixed reality environment with real-world objects and virtual objects supplemented over the real-world objects. A user can view the objects in the artificial reality environment and modify content in the artificial reality environment.

While XR systems can provide intuitive ways of viewing, navigating through, and interacting with objects in an XR environment, the process of designing and creating new XR environments and/or objects therein can be challenging and time-consuming. Often, creators need to provide or access digital assets that define surface textures, construct 3D objects with complex geometries and properties, and utilize building tools within the XR application and/or outside of the XR application (e.g., computer-aided design (CAD) modeling software, vector drawing software, etc.) that can be expensive and difficult to learn for non-technical users. Such a typical XR world design and building process can therefore be too difficult for non-technical users, limiting the participation of many users from creating their own virtual worlds.

### BRIEF DESCRIPTION OF THE DRAWINGS

FIG. 1 is a conceptual diagram illustrating an example VR world generator output based on a plain language description of a clubhouse.

FIG. 2 is a conceptual diagram illustrating an example VR world generator output based on a plain language description of an automobile show.

FIG. 3 is a block diagram illustrating an example processing pipeline for generating VR world data based on spoken plain language commands.

FIG. 4 is a flow diagram illustrating a process used in some implementations for generating a navigable virtual environment based on one or more plain language commands.

FIG. 5 is a block diagram illustrating an overview of devices on which some implementations of the present technology can operate.

FIG. 6A is a wire diagram illustrating a virtual reality headset which can be used in some implementations of the present technology.

FIG. 6B is a wire diagram illustrating a mixed reality headset which can be used in some implementations of the present technology.

FIG. 6C is a wire diagram illustrating controllers which, in some implementations, a user can hold in one or both hands to interact with an artificial reality environment.

FIG. 7 is a block diagram illustrating an overview of an environment in which some implementations of the present technology can operate.

FIG. 8 is a block diagram illustrating components which, in some implementations, can be used in a system employing the disclosed technology.

### DETAILED DESCRIPTION

Recent advances in artificial intelligence (AI) have enabled new applications for analyzing natural language and detecting the contents of images and videos. Natural language processing (NLP) techniques can parse and/or perform lexical analyses to tokenize words in a sentence or paragraph, generate word embeddings, and model syntactic and semantic relationships between those tokens. With respect to image analyses, convolutional neural networks (CNNs) can be trained to identify one or more objects and/or multiple instances of the same object from image data, such that images and videos can be semantically (and, in some cases, spatially) classified. With the advent of transformers and the development of “self-attention,” the relationships between individual objects in a scene can now be numerically related to develop a more contextualized understanding of the contents depicted in image data.

Many deep learning models that analyze image data are initially developed by repeatedly tuning the weights of the model against training data to either accurately predict existing training data labels or create statistically significant separations between unlabeled classes in variable space. In effect, learned weights of the hidden layers of a model provide a latent space representation between different semantically similar representations of an object. For example, a deep learning model trained to classify images of dogs with the label “dog” can effectively convert spatial image data into language, with that conversion being achieved because of the latent space representation relating the image-space representation of a dog with the language-space representation a dog. This latent space representation of information in different forms enables neural network architectures that can classify image data and/or its contents (e.g., an encoder) and, conversely, generate image data that probabilistically depicts one or more tags or words (e.g., autoregressive image generation).

Aspects of the present disclosure combine NLP and generative or autoregressive models to convert plain language words or commands into an automatically generated 3D environment. In an example embodiment, a user speaks aloud a command that describes the environment to be generated in plain language, which is captured by a microphone and converted to text data using a text-to-speech model. A natural language command processor can then parse the text data to extract at least a location (e.g., a specific place, a type of environment, etc.) and an activity described in the user's command. A generative virtual environment builder can receive the location and activity as inputs (along with embeddings, metadata, etc.) and generate a virtual environment (e.g., a skybox) and/or 3D objects within that virtual environment. Collectively, the natural language command processor and the generative virtual environment builder can be combined to form a VR world generator, which can generate interactive 3D virtual environments and/or objects therein based on plain language description of a location and/or an activity.

For example, if the user command is “scuba diving in Hawaii,” the natural language command processor can identify the location “Hawaii” (which may be semantically related to islands, tropical environments, etc.) and the activity “scuba diving” (which may be semantically related to the ocean, coastline, coral reefs, etc.). Then, the generative virtual environment builder might generate a skybox depicting a bay, coastline, island, ocean, and sky in the distance, along with objects in the environment associated with scuba diving (e.g., coral, fish, other marine life, etc.) positioned in the environment similarly to how those objects would be in the real world (e.g., underwater). The skybox and objects may form a navigable 3D virtual environment, which can be explored by the user to review the results of the generative world building process.

The natural language command processor may, in some implementations, perform pre-processing operations that initially tokenizes the words and/or otherwise contextualizes the words based on a pre-trained language model. For instance, a language model may be trained to classify a word or phrase as a location, an activity or experience, or something else, which initially serves to extract the relevant portions of a user's spoken command. Then, another language model (or the same language model) can infer one or more embeddings for each location word and for each activity word to develop a semantic understanding of the words spoken. The natural language command processor can provide the words, tokens, embeddings, or some combination thereof as inputs to the generative virtual environment builder. In other embodiments, the natural language command processor can be integrated into the model architecture of the generative virtual environment builder (i.e., a VR world generator, rather than a cascade of two or more separate models).

In various embodiments, the model(s) that form the VR world generator can be trained on some combination of images and/or videos that are tagged with metadata describing the contents or context of those images and/or videos. For instance, images and/or videos may be captured by users doing various activities at various locations, which may be geotagged and/or classified using machine learning to associate the images and/or videos with tags describing the contents of those images and/or videos. Additional training data can be generated (manually or automatically) which converts images and/or videos into 3D environments or objects (e.g., using a generative network), with the fidelity of the 2D-to-3D conversion being measured and tuned during training (e.g., using a discriminator network). In other words, some combination of manual labelling and automatic labelling can be used to create tagged images and/or videos on which supervised learning can be performed to relate words or phrases to graphical representations of those tags (and, in some cases, graphical representations of a combination of tags using transformers), followed by training a generative adversarial network (GAN) to produce 3D representations of 2D objects and environments.

With respect to the “scuba diving in Hawaii” example described above, the model may be trained on images and/or videos (e.g., captured by smartphones, action cameras, etc.) of people swimming, snorkeling, and scuba diving (i.e., semantically similar activities) along tropical beaches, coral reefs, or other coastal water (i.e., semantically similar locations). When the natural language command processor receives the command, it can parse the command to semantically identify the location (Hawaii and/or tropical island locations) and the experience (scuba diving or other coastal water-based activities). These semantic identifiers are mapped in latent space of the generative virtual environment builder, which can generate a skybox (e.g., a 2D image mapped to the inner surface of a 3D object, such as a cuboid or an ellipsoid).

Additionally, the generative virtual environment builder can generate objects and/or structures within the virtual environment, such as a beach, ocean, coral, fish, marine life, and/or other things commonly found in coastal waters that were captured in the training data.

After generating an initial virtual world, the VR world generator can be used to iteratively add or remove objects from the generated world, and/or to modify aspects of the generated skybox and/or the initially-generated objects. For instance, a user may inspect a generated virtual environment to assess whether the VR world generator created an accurate representation of the virtual environment that the user intended to create. If an aspect of the virtual environment was either inaccurately generated, or if the user wishes to otherwise alter aspects of the generated virtual environment, the user may issue subsequent natural language commands to remove objects, add new objects, change details about various objects, and/or change details about the skybox. For example, if the VR world generator created a virtual environment in coastal waters of a tropical island with a coral reef in response to the command “scuba diving in Hawaii,” the user may wish to update the type of coral reef (e.g., “add staghorn coral,” “increase size of coral reef,” etc.), add or remove fish or other marine life (e.g., “add starfish,” “remove eels,” etc.), and/or change aspects about the environment more generally (e.g., “increase depth,” “add kelp plants,” etc.). In this manner, the user can issue secondary plain language commands to tune the environment to achieve a particular environment or aesthetic. These secondary plain language commands and adjustments that the user keeps may serve as additional training data to the VR world generator model(s), such that the model(s) can better infer the intent of the user from the initial plain language commands over time.

As described herein, the terms “plain language” and “natural language” may be used interchangeably to refer to language that is not in a formally-defined syntactic or semantic structure, such as a programming language. Thus, commands that are “plain language” or “natural language” may generally refer to phrases or sentences that do not necessarily follow a rigid set of rules and do not otherwise have to be interpreted or translated by a special application (e.g., a compiler). In addition, the terms “command” and “description” may be used interchangeably to refer to the substance of a plain or natural language string.

As described herein, the terms “navigable virtual environment,” “interactive 3D virtual environments,” and “VR world data” may be used interchangeably to refer to data that is used to render 2D assets and/or 3D assets in a 3D virtual environment, which can be explored with an avatar or virtual camera of a game engine or VR engine. VR world data differs from generated image data in that VR world data can either map a 2D image onto a 3D surface (e.g., as in a skybox, a surface texture, etc.), and/or may be a geometric model defining an object shape in 3D space. The format of VR world data may vary among implementations depending on the game engine used to render the generated skybox and/or generated 3D objects.

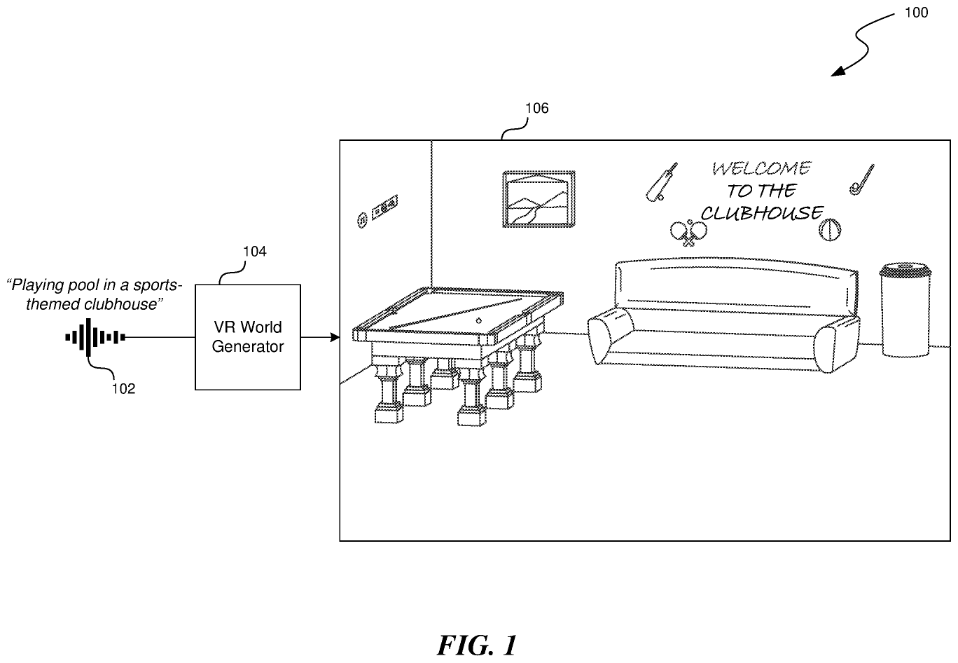

FIG. 1 is a conceptual diagram 100 illustrating an example VR world generator output based on a plain language description of a clubhouse. In this example, a user speaks the command “playing pool in a sports-themed clubhouse” 102, which is provided as an input into a VR world generator 104 (e.g., as audio data, as text data determined using a text-to-speech model, etc.). The VR world generator 104 processes the command to identify the location as “sports-themed clubhouse” and the experience as “playing pool.” In this example, the natural language command processor and/or the VR world generator may use attention-based models such as transformers to infer a semantic context that the word “pool” here refers to the cue sport, and not other possible meanings (e.g., other homonyms such as swimming pools, a group of resources, etc.). In addition, the natural language processor may further tokenize or perform other lexical analyses to determine the location to be “clubhouse,” which is qualified by the adjective “sports-themed” to specify a particular aesthetic or decorative styling for the location.

The VR world generator 104 then generates 3D environment 106 based on the command 102. As shown in FIG. 1, the VR world generator 104 can generate a room with wall decorations (e.g., sports paraphernalia, pictures, or other wall-mounted decorations typical of clubhouses, etc.) and furniture (e.g., a pool table, a couch, a trash can, etc.). In this example, the generated “skybox” includes the geometry and dimensions of the room, along with any wall textures. In other words, the term “skybox” used herein may refer to either projected graphics onto a 3D surface-which may be reachable, or unreachable, depending on the particular case.

Additionally, each object generated by the VR world generator 104 is associated with an absolute or relative position and orientation within the environment, such that a game engine or the like can render the objects within particular locations of a 3D environment. In some implementations, the VR world generator 104 can generate properties about the objects within the environmen—such as whether they are fixed or movable, whether the objects are collidable, and/or any behavior or interactivity associated with the objects. For example, with respect to the example shown in FIG. 1, the pool table may be fixed and collidable such that a user's avatar cannot move through it, any pool balls may be collidable and movable, and the pool cue may be movable and able to be picked up and wielded by a user's player character. In some cases, video training data may be used to train the model to identify objects which are stationary (e.g., pool table and couch) and which are movable or interactable (e.g., videos of people holding or using pool cues). Such properties of generated objects may be automatically initialized by the VR world generator 104, and/or manually configured by the user after generating the virtual environment.

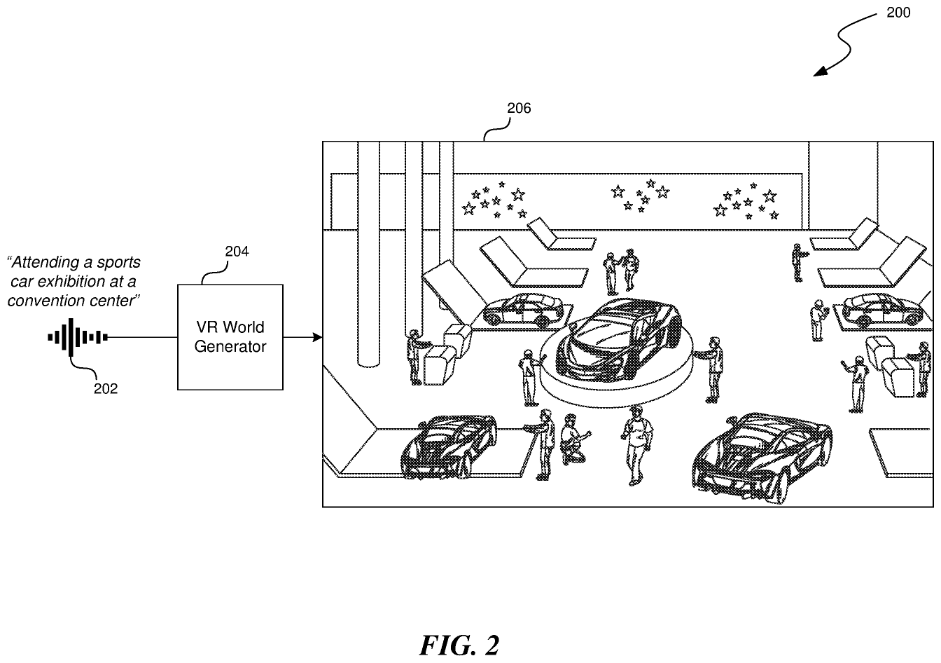

FIG. 2 is a conceptual diagram 200 illustrating an example VR world generator output based on a plain language description of an automobile show. In this example, a user speaks the command “attending a sports car exhibition at a convention center” 202, which is provided as an input into a VR world generator 204 (e.g., as audio data, as text data determined using a text-to-speech model, etc.). The VR world generator 204 can process the command to identify the location as “convention center” and the experience as “attending a sports car exhibition.” In addition, the natural language processor can tokenize or perform other lexical analyses to qualify the location as a convention center (e.g., an indoor space in which a wide variety of events are held) which is qualified by “sports car exhibition” (e.g., displaying sports cars from different manufacturers for viewing by attendees). In other words, the “sports car exhibition” portion of the command may be considered a part of the activity (i.e., what is being attended in a convention center), or as part of the location (i.e., what the convention center is hosting). It will be appreciated that any of the above interpretations may be used by the VR world generator 204 to generate the 3D environment 206.

The VR world generator 204 then generates 3D environment 206 based on the command 202. As shown in FIG. 2, the VR world generator 204 can generate a large room with supporting structures (e.g., load-bearing columns), display stages with different sports cars positioned thereon, and other furniture typically found at automobile shows (e.g., booths, tables, etc.). As with the previous example, the generated skybox may include the geometry and dimensions of the room, along with any wall textures—all of which may be reachable, or only a portion of which being reachable.

In some cases, the VR world generator 204 may generate avatars that represent either non-playable characters (NPCs), or act as placeholders for playable characters (e.g., potential avatars of other users). In cases where the avatars are NPCs, the VR world generator 204 may define a default behavior for the NPCs (e.g., walking, pausing, interacting with other NPCs periodically, etc.), which may be modified by the user after the virtual environment is generated.

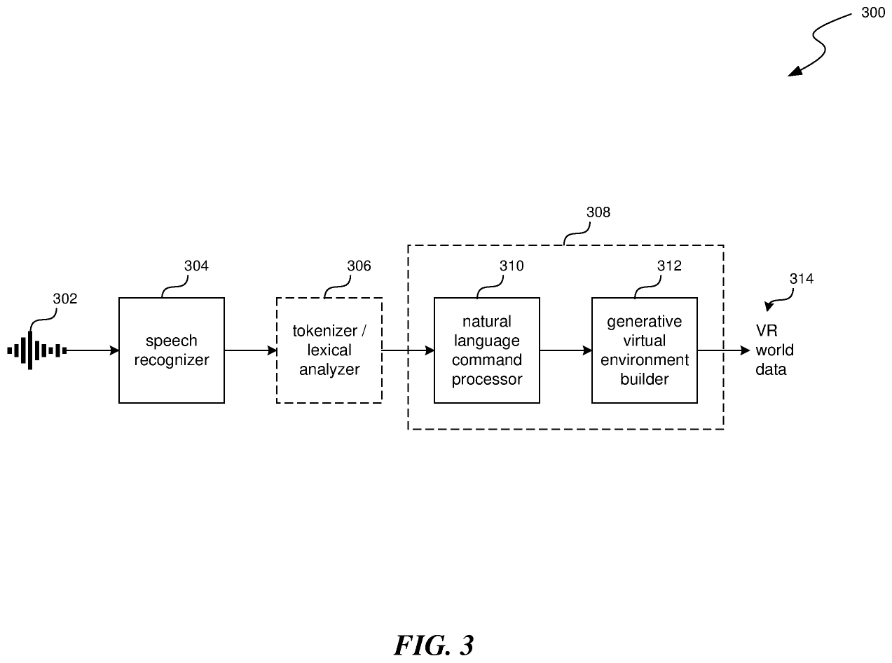

FIG. 3 is a block diagram illustrating an example processing pipeline 300 for generating VR world data based on spoken plain language commands. The pipeline 300 initially receives an audio sample 302, which is provided as an input to speech recognizer 304. Speech recognizer 304 can use machine learning models and the like to perform speech-to-text operations, which generates a transcription of any words spoken in the audio sample 302. In some implementations, a tokenizer or lexical analyzer 306 can receive the transcription (e.g., text data representing the spoken command) to parse the command into different grammatical units and/or to perform semantic analyses on the location and experience to append metadata to the command to improve the accuracy and/or robustness of subsequent operations of the pipeline 300.

The command and/or the output of the tokenizer or lexical analyzer 306 is then provided to a VR world generator 308, which includes a natural language command processor 310 and a generative virtual environment builder 312. As described above, the natural language command processor 310 can identify a location and an experience from the command (e.g., using a pre-trained language model), which serve as inputs to the generative virtual environment builder 312. The generative virtual environment builder 312 can generate a virtual environment comprised of a skybox and/or one or more 3D objects (along with their respective locations and orientations within the environment) using a generative model, such as a generative adversarial network (GAN). The output of the generative virtual environment builder 312 may be a data payload that combines skybox data, 3D object data, and/or 3D object metadata into VR world data 314, which collectively can be used to generate a navigable 3D environment.

In some cases, a combination of automatic data labeling, data augmentation, and/or other automated processes may be used to enrich image and video data to improve the robustness of the generative model of the generative virtual environment builder 312. For example, image segmentation models can be used to delineate pixels associated with different categories of objects, and/or to differentiate between different instances of the same object. The subset of pixels associated with a particular instance of an object may be used to train the generative model to associate a shape, size, and geometry of a given type of object. In some implementations, depth estimation models may be used to infer 3D geometries of surfaces or objects from a 2D image (e.g., to infer a depth map from an image or video frame), with the depth map being used as further training data to improve the fidelity of generated 3D objects. Training data may further include stereoscopic videos and/or 3D videos (e.g., spatial data captured from time of flight sensors or the like) to further improve the accuracy of generated 3D object geometries.

Collectively, the pipeline 300 may leverage one or more deep learning models to enable users to naturally describe 3D environments (i.e., without memorizing a specialized set of commands) and generate 3D environments based on those descriptions. An advantage of the VR world generator 308 is that it enables non-technical users to meaningfully participate in the VR world building process, thereby facilitating more equitable participation in the creation of VR worlds and, more broadly, the metaverse.

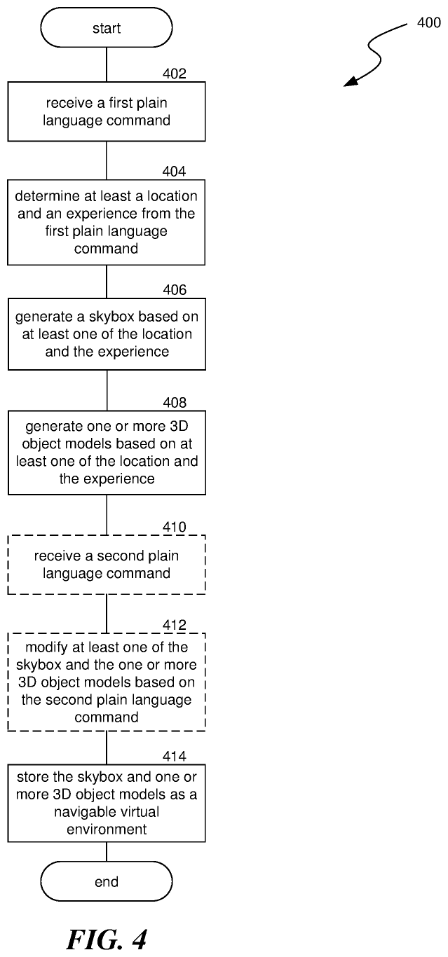

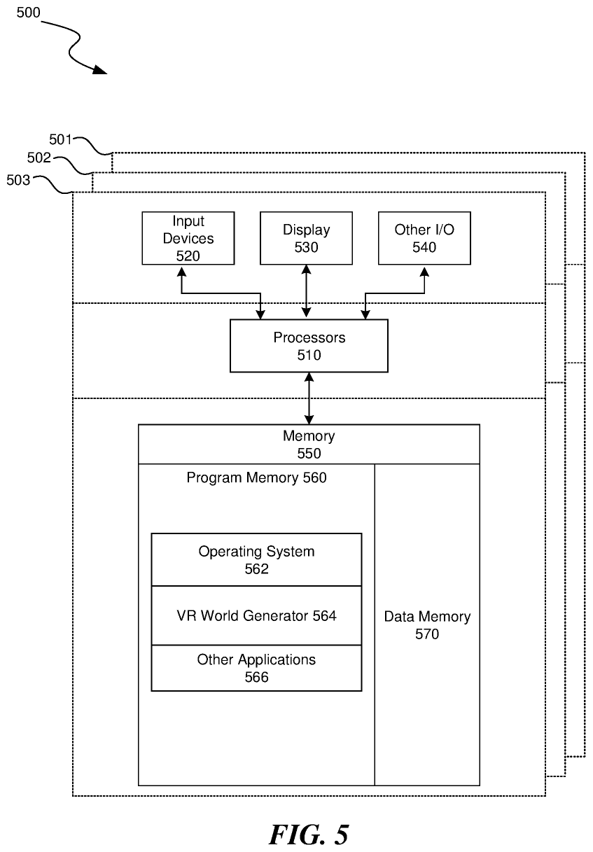

FIG. 4 is a flow diagram illustrating a process 400 used in some implementations for generating a navigable virtual environment based on one or more plain language commands. In some implementations, process 400 can be performed as a response to a user interacting with a virtual button, selecting a menu option, speaking a key word or wake word, and/or otherwise manually triggered by a user wishing to generate a new virtual environment. Process 400 can be performed by, for example, VR world generator 564 of FIG. 5, either on a server or combination of servers over a network, or locally on a user system or device, i.e., an XR device (e.g., a head-mounted display) or 2D device, such as a computer or other display or processing device. In some implementations, some steps of process 400 can be performed on a server, while other steps of process 400 can be performed locally on a user device. Although illustrated as having only one iteration, it is contemplated that process 400 can be performed multiple times, repeatedly, iteratively, consecutively, concurrently, in parallel, etc., as requests to generate 3D environments and/or modify aspects of those 3D environments. Some steps of process 400 can described as “generating” skyboxes or 3D object models, which may involve providing input data to pre-trained model(s) and capturing the output from those model(s).

At block 402, process 400 can receive a first plain language command. As described above, the plain language command may be a typed or text-to-speech transcription of a description of a 3D virtual environment from a user.

At block 404, process 400 can determine at least a location and an experience from the first plain language command. In some embodiments, a natural language command processor can perform some combination of tokenization, lexical analysis, and/or otherwise apply a language model to parse the plain language command to identify a location (and/or a semantic category of locations) and an experience or activity (and/or a semantic category of experiences or activities). In some cases, the location may be a specific place (which may fit within a category of locations), or may be a category of place (e.g., an island, a mountain range, a coffee shop, a restaurant, etc.).

The experience or activity may semantically relate to a particular time of day, season, decorations within the environment, or objects expected to be within the environment. For example, an experience of “skiing” in the mountains may imply the existence of snow, which itself implies that the season is winter. Conversely, an experience “hiking” in the mountains may imply a summer or autumn season where there is little to no snow in the mountains.

At block 406, process 400 can generate a skybox based on at least one of the location and the experience. The skybox may be represented as data defining the dimensions, geometry, textures, and/or a projected image onto surface(s) of the skybox, all of which may be packaged into a data structure that can be interpreted by a game engine to render the skybox in real time. The projected image onto the surface of the skybox may be initially generated by a generative virtual environment builder (e.g., a GAN) which is subsequently resized, re-shaped, or otherwise projected onto the inner surface of the skybox geometry.

At block 408, process 400 can generate one or more 3D object models based on at least one of the location and the experience. Each 3D object may be related to the location and/or the experience, such as objects identified or tagged in the training data. In some cases, objects may be fixed structures that form the shape of the terrain, fixed objects that cannot be moved by users when the 3D environment Is deployed, objects within the environment that can be moved and/or interacted with, and/or objects that autonomously move (e.g., animals, NPCs, weather elements, etc.). Similar to the skybox, each 3D object may be represented as data defining the dimensions, geometry, textures, kinematics, properties, location, orientation, and/or a projected image onto the surface(s) of the 3D object, some or all of which may be packaged into a data structure that can be read by a game engine to render the 3D object within a virtual environment.

In some implementations, the generated skybox and/or one or more 3D object models can be iteratively modified, removed, or added to via subsequent plain language commands by the user. At block 410, process 400 can receive a second plain language command. The second plain language command may be semantically related to the first plain language command, at least insofar as the second plain language command is used to qualify or modify the generated VR environment from the first plain language command. At block 412, process 400 may modify at least one of the skybox and the one or more 3D object models based on the second plain language command. For example, after generating a tropical scuba diving-related 3D environment, second plain languages such as “add starfish,” “make the reef shallower,” or “remove clownfish” can cause the VR world generator to add 3D objects, remove 3D objects, and/or adjust the terrain or skybox.

At block 414, process 400 can store the skybox and one or more 3D object models as a navigable virtual environment. For instance, the generated skybox and one or more 3D object models can be stored as data on a server, which can subsequently be retrieved by users and interpreted by the game engines running on those users' devices to instantiate navigable 3D virtual environments. In some cases, the creator of the 3D virtual environment or other creators might access the stored virtual environment in a separate portion of the VR application or in a separate application entirely to manually modify and/or build upon that virtual environment. In this manner, the VR world generator can be used to rapidly generate an initial environment, with subsequent aspects of the environment being adjusted manually by the creator thereafter with other VR world building tools.

FIG. 5 is a block diagram illustrating an overview of devices on which some implementations of the disclosed technology can operate. The devices can comprise hardware components of a device 500 that generate navigable 3D virtual environments. In various implementations, computing system 500 can include a single computing device 503 or multiple computing devices (e.g., computing device 501, computing device 502, and computing device 503) that communicate over wired or wireless channels to distribute processing and share input data. In some implementations, computing system 500 can include a stand-alone headset capable of providing a computer created or augmented experience for a user without the need for external processing or sensors. In other implementations, computing system 500 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 500 can include one or more processor(s) 510 (e.g., central processing units (CPUs), graphical processing units (GPUs), holographic processing units (HPUs), etc.) Processors 510 can be a single processing unit or multiple processing units in a device or distributed across multiple devices (e.g., distributed across two or more of computing devices 501-503).

Device 500 can include one or more input devices 520 that provide input to the Processor(s) 510 (e.g., CPU(s), GPU(s), HPU(s), etc.), notifying it of actions. The actions can be mediated by a hardware controller that interprets the signals received from the input device and communicates the information to the processors 510 using a communication protocol. Input devices 520 include, for example, a mouse, a keyboard, a touchscreen, an infrared sensor, a touchpad, a wearable input device (e.g., a haptics glove, a bracelet, a ring, an earring, a necklace, a watch, etc.), a camera- or image-based input device, a microphone, or other user input devices.

Processors 510 can be coupled to other hardware devices, for example, with the use of a bus, such as a PCI bus or SCSI bus. The processors 510 can communicate with a hardware controller for devices, such as for a display 530. Display 530 can be used to display text and graphics. In some implementations, display 530 provides graphical and textual visual feedback to a user. In some implementations, display 530 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 540 can also be coupled to the processor, such as a network card, video card, audio card, USB, firewire or other external device, camera, printer, speakers, CD-ROM drive, DVD drive, disk drive, etc.

In some implementations, input from the I/O devices 540, such as cameras, depth sensors, IMU sensor, GPS units, LIDAR or other time-of-flights sensors, etc. can be used by the computing system 500 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 500 or another computing system that had mapped the area. The SLAM system can track the user within the area based on factors such as GPS data, matching identified objects and structures to mapped objects and structures, monitoring acceleration and other position changes, etc.

In some implementations, the device 500 also includes a communication device capable of communicating wirelessly or wire-based with a network node. The communication device can communicate with another device or a server through a network using, for example, TCP/IP protocols. Device 500 can utilize the communication device to distribute operations across multiple network devices.

The processors 510 can have access to a memory 550, which can be contained on one of the computing devices of computing system 500 or can be distributed across of the multiple computing devices of computing system 500 or other external devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 550 can include program memory 560 that stores programs and software, such as an operating system 562, VR world generator 564, and other application programs 566. Memory 550 can also include data memory 570, e.g., image data, video data, image and video data tags, geolocation data, language models, image classification models, object detection models, image segmentation models, configuration data, settings, user options or preferences, etc., which can be provided to the program memory 560 or any element of the device 500.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

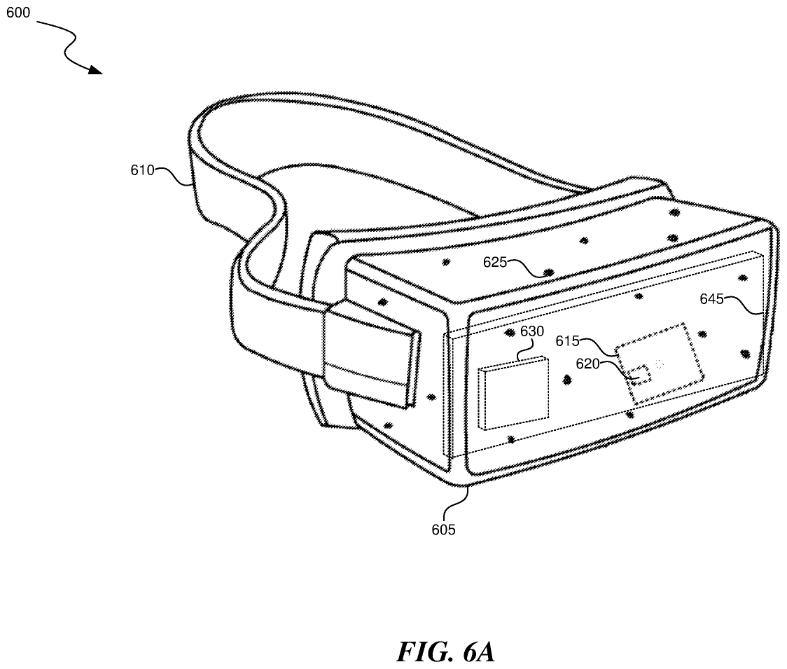

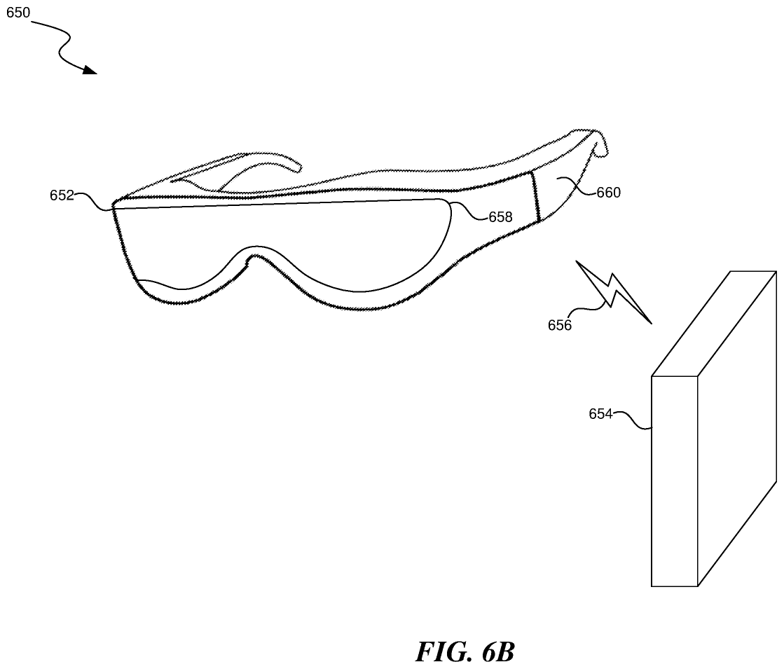

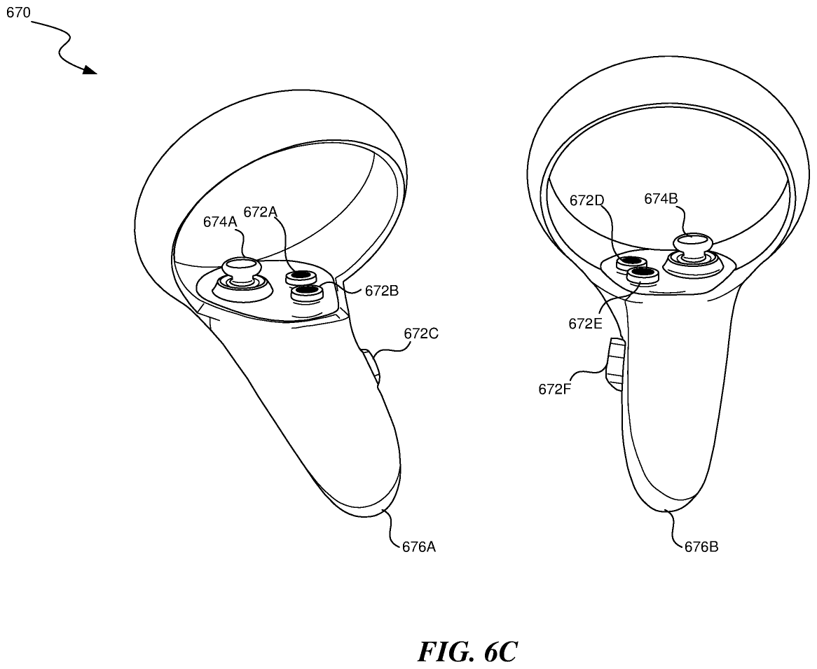

FIG. 6A is a wire diagram of a virtual reality head-mounted display (HMD) 600, in accordance with some embodiments. The HMD 600 includes a front rigid body 605 and a band 610. The front rigid body 605 includes one or more electronic display elements of an electronic display 645, an inertial motion unit (IMU) 615, one or more position sensors 620, locators 625, and one or more compute units 630. The position sensors 620, the IMU 615, and compute units 630 may be internal to the HMD 600 and may not be visible to the user. In various implementations, the IMU 615, position sensors 620, and locators 625 can track movement and location of the HMD 600 in the real world and in an artificial reality environment in three degrees of freedom (3DoF) or six degrees of freedom (6DoF). For example, the locators 625 can emit infrared light beams which create light points on real objects around the HMD 600. As another example, the IMU 615 can include e.g., one or more accelerometers, gyroscopes, magnetometers, other non-camera-based position, force, or orientation sensors, or combinations thereof. One or more cameras (not shown) integrated with the HMD 600 can detect the light points. Compute units 630 in the HMD 600 can use the detected light points to extrapolate position and movement of the HMD 600 as well as to identify the shape and position of the real objects surrounding the HMD 600.

The electronic display 645 can be integrated with the front rigid body 605 and can provide image light to a user as dictated by the compute units 630. In various embodiments, the electronic display 645 can be a single electronic display or multiple electronic displays (e.g., a display for each user eye). Examples of the electronic display 645 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 600 can be coupled to a core processing component such as a personal computer (PC) (not shown) and/or one or more external sensors (not shown). The external sensors can monitor the HMD 600 (e.g., via light emitted from the HMD 600) which the PC can use, in combination with output from the IMU 615 and position sensors 620, to determine the location and movement of the HMD 600.

FIG. 6B is a wire diagram of a mixed reality HMD system 650 which includes a mixed reality HMD 652 and a core processing component 654. The mixed reality HMD 652 and the core processing component 654 can communicate via a wireless connection (e.g., a 60 GHZ link) as indicated by link 656. In other implementations, the mixed reality system 650 includes a headset only, without an external compute device or includes other wired or wireless connections between the mixed reality HMD 652 and the core processing component 654. The mixed reality HMD 652 includes a pass-through display 658 and a frame 660. The frame 660 can house various electronic components (not shown) such as light projectors (e.g., LASERs, LEDs, etc.), cameras, eye-tracking sensors, MEMS components, networking components, etc.

The projectors can be coupled to the pass-through display 658, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 654 via link 656 to HMD 652. Controllers in the HMD 652 can convert the image data into light pulses from the projectors, which can be transmitted via the optical elements as output light to the user's eye. The output light can mix with light that passes through the display 658, allowing the output light to present virtual objects that appear as if they exist in the real world.

Similarly to the HMD 600, the HMD system 650 can also include motion and position tracking units, cameras, light sources, etc., which allow the HMD system 650 to, e.g., track itself in 3DoF or 6DoF, track portions of the user (e.g., hands, feet, head, or other body parts), map virtual objects to appear as stationary as the HMD 652 moves, and have virtual objects react to gestures and other real-world objects.

FIG. 6C illustrates controllers 670 (including controller 676A and 676B), which, in some implementations, a user can hold in one or both hands to interact with an artificial reality environment presented by the HMD 600 and/or HMD 650. The controllers 670 can be in communication with the HMDs, either directly or via an external device (e.g., core processing component 654). The controllers can have their own IMU units, position sensors, and/or can emit further light points. The HMD 600 or 650, external sensors, or sensors in the controllers can track these controller light points to determine the controller positions and/or orientations (e.g., to track the controllers in 3DoF or 6DoF). The compute units 630 in the HMD 600 or the core processing component 654 can use this tracking, in combination with IMU and position output, to monitor hand positions and motions of the user. The controllers can also include various buttons (e.g., buttons 672A-F) and/or joysticks (e.g., joysticks 676A-B), which a user can actuate to provide input and interact with objects.

In various implementations, the HMD 600 or 650 can also include additional subsystems, such as an eye tracking unit, an audio system, various network components, etc., to monitor indications of user interactions and intentions. For example, in some implementations, instead of or in addition to controllers, one or more cameras included in the HMD 600 or 650, or from external cameras, can monitor the positions and poses of the user's hands to determine gestures and other hand and body motions. As another example, one or more light sources can illuminate either or both of the user's eyes and the HMD 600 or 650 can use eye-facing cameras to capture a reflection of this light to determine eye position (e.g., based on set of reflections around the user's cornea), modeling the user's eye and determining a gaze direction.

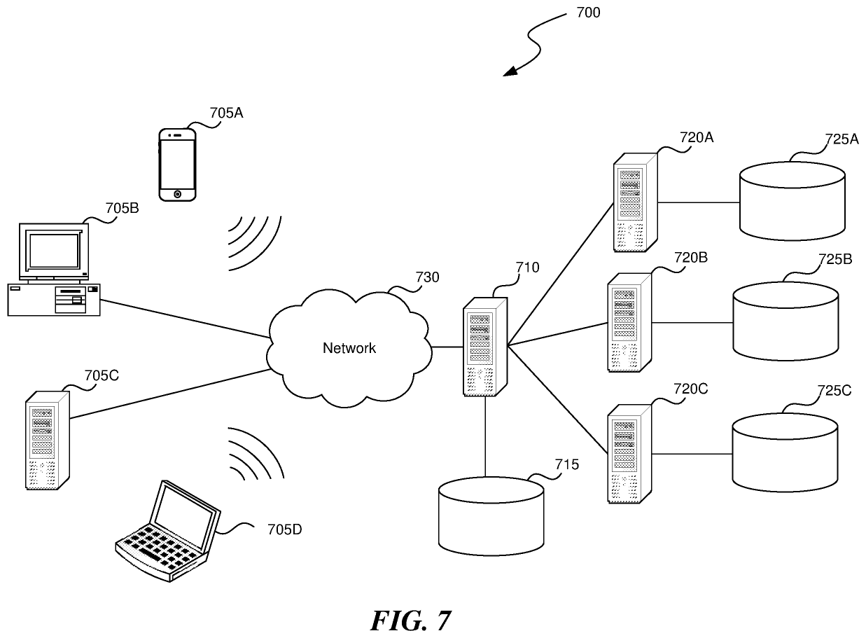

FIG. 7 is a block diagram illustrating an overview of an environment 700 in which some implementations of the disclosed technology can operate. Environment 700 can include one or more client computing devices 705A-D, examples of which can include device 500. Client computing devices 705 can operate in a networked environment using logical connections through network 730 to one or more remote computers, such as a server computing device.

In some implementations, server 710 can be an edge server which receives client requests and coordinates fulfillment of those requests through other servers, such as servers 720A-C. Server computing devices 710 and 720 can comprise computing systems, such as device 500. Though each server computing device 710 and 720 is displayed logically as a single server, server computing devices can each be a distributed computing environment encompassing multiple computing devices located at the same or at geographically disparate physical locations. In some implementations, each server 720 corresponds to a group of servers.

Client computing devices 705 and server computing devices 710 and 720 can each act as a server or client to other server/client devices. Server 710 can connect to a database 715. Servers 720A-C can each connect to a corresponding database 725A-C. As discussed above, each server 720 can correspond to a group of servers, and each of these servers can share a database or can have their own database. Databases 715 and 725 can warehouse (e.g., store) information. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN), but can also be other wired or wireless networks. Network 730 may be the Internet or some other public or private network. Client computing devices 705 can be connected to network 730 through a network interface, such as by wired or wireless communication. While the connections between server 710 and servers 720 are shown as separate connections, these connections can be any kind of local, wide area, wired, or wireless network, including network 730 or a separate public or private network.

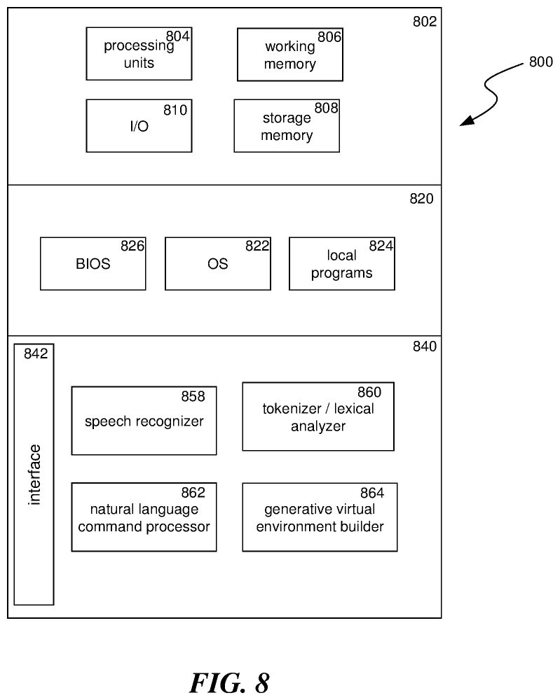

FIG. 8 is a block diagram illustrating components 800 which, in some implementations, can be used in a system employing the disclosed technology. The components 800 include hardware 802, general software 820, and specialized components 840. As discussed above, a system implementing the disclosed technology can use various hardware including processing units 804 (e.g. CPUs, GPUs, APUs, etc.), working memory 806, storage memory 808 (local storage or as an interface to remote storage, such as storage 715 or 725), and input and output devices 810. In various implementations, storage memory 808 can be one or more of: local devices, interfaces to remote storage devices, or combinations thereof. For example, storage memory 808 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 720). Components 800 can be implemented in a client computing device such as client computing devices 705 or on a server computing device, such as server computing device 710 or 720.

General software 820 can include various applications including an operating system 822, local programs 824, and a basic input output system (BIOS) 826. Specialized components 840 can be subcomponents of a general software application 820, such as local programs 824. Specialized components 840 can include speech recognizer 858, tokenizer/lexical analyzer 860, natural language command processor 862, generative virtual environment builder 864, and components which can be used for providing user interfaces, transferring data, and controlling the specialized components, such as interface 842. In some implementations, components 800 can be in a computing system that is distributed across multiple computing devices or can be an interface to a server-based application executing one or more of specialized components 840.

Speech recognizer 858 can use machine learning models and the like to perform speech-to-text operations, which generates a transcription of input speech audio. Additional details on speech recognition are provided above with relation to, e.g., block 304 of FIG. 3 and block 404 of FIG. 4.

Tokenizer/lexical analyzer 860 can receive speech text and parse it into different grammatical units to perform semantic analyses for a location and experience determination. Additional details on tokenizing and lexicographical analysis of text are provided above with relation to, e.g., block 306 of FIG. 3 and block 404 of FIG. 4.

Natural language command processor 862 can identify a location and an experience from the command (e.g., using a pre-trained language model). Additional details on identifying a location and experience from input language/tokens are provided above with relation to, e.g., block 310 of FIG. 3 and block 404 of FIG. 4.

Generative virtual environment builder 864 can generate a virtual skybox and/or one or more 3D objects matching input location and experience. In some cases, this is performed in two steps: building 2D content items corresponding to input location and experience identifiers and then building 3D components based on the 2D elements (e.g., using generative adversarial networks (GAN)). Additional details on generating a skybox and/or one or more 3D objects are provided above with relation to, e.g., block 312 of FIG. 3 and blocks 406 and 408 of FIG. 4.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/we claim:

1. A method for generating a navigable 3D virtual environment, the method comprising:
receiving a command in plain language that describes a virtual environment;
determining, using a natural language command processor, (i) a location portion and (ii) an experience portion of the command;
generating, using a generative virtual environment builder comprising one or more first machine learning models, a skybox based on the location portion of the command, wherein the skybox comprises at least a shape and an image projected onto the shape;
generating, using a generative virtual environment builder comprising one or more second machine learning models, one or more 3D object models based on both the location portion and the experience portion of the command, wherein each 3D object model comprises at least a geometry and a location within the navigable 3D virtual environment;
creating a 3D virtual environment model that combines the skybox and the one or more 3D object models, wherein the 3D virtual environment model is navigable using an artificial reality (XR) device; and
storing the 3D virtual environment model on a data storage device.

2. The method of claim 1, wherein determining the location portion includes applying the natural language command processor to identify a specific geographic place or a type of environment.

3. The method of claim 1, further comprising determining embeddings and metadata associated with the command, wherein the generative virtual environment builder receives, as part of its input, the embeddings and metadata to generate the skybox and the one or more 3D object models.

4. The method of claim 1, wherein generating the skybox includes identifying elements semantically related to the determined location portion and adding representations of the elements to the skybox.

5. The method of claim 1, wherein the determining (i) the location portion and (ii) the experience portion of the command comprises:
pre-processing the command by tokenizing phrases of the command and contextualizing the phrases using a first language model pre-trained to classify a phrases according to location or activity designators.

6. The method of claim 5, wherein the determining (i) the location portion and (ii) the experience portion of the command further comprises:
applying a second language model, to the tokenized and contextualized phrases, and receiving, from the second language model, one or more embeddings;
wherein the one or more embeddings are provided to the one or more first machine learning models to generate the skybox and the one or more embeddings are provided to the one or more second machine learning models to generate the one or more 3D object models.

7. The method of claim 1, wherein the one or more first machine learning models and/or the one or more second machine learning models:
A) include a 2D modeling portion trained on a combination of images and/or videos that are tagged with metadata describing the contents or context of those images and/or videos and B) produce one or more 2D representations based on one or more input tags, and
include a generative portion trained to take one or more 2D representations and produce one or more 3D representations.

8. The method of claim 1,
wherein determining the location portion comprises identifying semantic identifiers for the location portion; and
wherein the generating the skybox comprises mapping the semantic identifiers for the location portion in latent space for the one or more second machine learning models of the generative virtual environment builder.

9. The method of claim 1, further comprising iteratively updating the 3D virtual environment model by:
receiving a further natural language command;
identifying a target of the further natural language command; and
changing an aspect of the target based on the further natural language command.

10. The method of claim 9, further comprising updating training of the one or more first machine learning models and/or the one or more second machine learning models using additional training items created based on pairing the target and the changed an aspect of the target.

11. The method of claim 1, wherein the generated one or more 3D object models are generated with properties specifying whether each of the one or more 3D object models is fixed or movable.

12. A computer-readable storage medium storing instructions that, when executed by a computing system, cause the computing system to perform a process for generating a navigable 3D virtual environment, the process comprising:
receiving a command in plain language that describes a virtual environment;
determining, using a natural language command processor, (i) a location portion and (ii) an experience portion of the command;
generating, using a generative virtual environment builder comprising one or more first machine learning models, a skybox based on the location portion of the command, wherein the skybox comprises at least a shape and an image projected onto the shape;
generating, using a generative virtual environment builder comprising one or more second machine learning models, one or more 3D object models based on both the location portion and the experience portion of the command, wherein each 3D object model comprises at least a geometry and a location within the navigable 3D virtual environment;
creating a 3D virtual environment model that combines the skybox and the one or more 3D object models, wherein the 3D virtual environment model is navigable using an artificial reality (XR) device; and
storing the 3D virtual environment model on a data storage device.

13. The computer-readable storage medium of claim 12, wherein the process further comprises determining embeddings and metadata associated with the command, wherein the generative virtual environment builder receives, as part of its input, the embeddings and metadata to generate the skybox and the one or more 3D object models.

14. The computer-readable storage medium of claim 12, wherein generating the skybox includes identifying elements semantically related to the determined location portion and adding representations of the elements to the skybox.

15. The computer-readable storage medium of claim 12, wherein the determining (i) the location portion and (ii) the experience portion of the command comprises:
pre-processing the command by tokenizing phrases of the command and contextualizing the phrases using a first language model pre-trained to classify a phrases according to location or activity designators.

16. The computer-readable storage medium of claim 15, wherein the determining (i) the location portion and (ii) the experience portion of the command further comprises:
applying a second language model, to the tokenized and contextualized phrases, and receiving, from the second language model, one or more embeddings;
wherein the one or more embeddings are provided to the one or more first machine learning models to generate the skybox and the one or more embeddings are provided to the one or more second machine learning models to generate the one or more 3D object models.

17. The computer-readable storage medium of claim 12, wherein the one or more first machine learning models and/or the one or more second machine learning models:
A) include a 2D modeling portion trained on a combination of images and/or videos that are tagged with metadata describing the contents or context of those images and/or videos and B) produce one or more 2D representations based on one or more input tags, and
include a generative portion trained to take one or more 2D representations and produce one or more 3D representations.

18. A computing system for generating a navigable 3D virtual environment, the computing system comprising:
one or more processors; and
one or more memories storing instructions that, when executed by the one or more processors, cause the computing system to perform a process comprising:
receiving a command in plain language that describes a virtual environment;
determining, using a natural language command processor, (i) a location portion and (ii) an experience portion of the command;
generating, using a generative virtual environment builder comprising one or more first machine learning models, a skybox based on the location portion of the command, wherein the skybox comprises at least a shape and an image projected onto the shape;
generating, using a generative virtual environment builder comprising one or more second machine learning models, one or more 3D object models based on both the location portion and the experience portion of the command, wherein each 3D object model comprises at least a geometry and a location within the navigable 3D virtual environment;
creating a 3D virtual environment model that combines the skybox and the one or more 3D object models, wherein the 3D virtual environment model is navigable using an artificial reality (XR) device; and
storing the 3D virtual environment model on a data storage device.

19. The computing system of claim 18,
wherein determining the location portion comprises identifying semantic identifiers for the location portion; and
wherein the generating the skybox comprises mapping the semantic identifiers for the location portion in latent space for the one or more second machine learning models of the generative virtual environment builder.

20. The computing system of claim 18, wherein the process further comprises iteratively updating the 3D virtual environment model by:
receiving a further natural language command;
identifying a target of the further natural language command;
changing an aspect of the target based on the further natural language command; and
updating training of the one or more first machine learning models and/or the one or more second machine learning models using additional training items created based on pairing the target and the changed an aspect of the target.
